(19) United States
(12) Patent Application Publication
(10) Pub. No.: US 2026/0175920 A1
(43) Pub. Date: Jun. 25, 2026

(54) VEHICLE BODY STRUCTURE

(71) Applicant: TOYOTA JIDOSHA KABUSHIKI KAISHA, Aichi-ken (JP)

(72) Inventors: Koji AMEMIYA, Okazaki-shi (JP); Kyohei MOMIYAMA, Anjo-shi (JP)

(21) Appl. No.: 19/409,736

(22) Filed: Dec. 5, 2025

(30) Foreign Application Priority Data
Dec. 25, 2024 (JP) 2024-229330

(51) Int. Cl. B62D 25/08; B62D 25/14

(52) U.S. Cl. CPC B62D 25/085; B62D 25/14

(57) ABSTRACT

A vehicle body structure including: a die-cast front frame member including left and right front wheel houses, and a lower side wall portion that connects the left and right front wheel houses and that extends in a vehicle up-down direction; and a resin dash panel that is attached to the lower side wall portion, wherein the dash panel includes a bent portion that is bent so as to cover an upper edge portion of the lower side wall portion from a vehicle upper side and a vehicle rear side, and a sealing material is provided in a liquid-tight state between the upper edge portion and the bent portion.

### CROSS-REFERENCE TO RELATED APPLICATION

This application is based on and claims priority under 35 USC 119 from Japanese Patent Application No. 2024-229330 filed on Dec. 25, 2024, the disclosure of which is incorporated by reference herein.

### BACKGROUND

### Technical Field

The present disclosure relates to a vehicle body structure.

### Related Art

Japanese Patent Application Laid-Open (JP-A) No. H6-72354 discloses a vehicle including a dash panel.

The invention of JP-A No. H6-72354 has room for improvement with respect to sealing performance between a vehicle body frame member provided at a front portion of the vehicle and the dash panel.

In consideration of the above circumstances, an object of the present disclosure is to obtain a vehicle body structure that is capable of preventing liquid that has adhered to a front face of a resin dash panel that is supported by a die-cast front frame member from passing through rearward between the front frame member and the dash panel.

### SUMMARY

A vehicle body structure of a first aspect includes: a die-cast front frame member including left and right front wheel houses, and a lower side wall portion that connects the left and right front wheel houses and that extends in a vehicle up-down direction; and a resin dash panel that is attached to the lower side wall portion, wherein the dash panel includes a bent portion that is bent so as to cover an upper edge portion of the lower side wall portion from a vehicle upper side and a vehicle rear side, and a sealing material is provided in a liquid-tight state between the upper edge portion and the bent portion.

The die-cast front frame member of the vehicle body structure of the first aspect includes the left and right front wheel houses, and the lower side wall portion that connects the left and right front wheel houses and that extends in the vehicle up-down direction. The resin dash panel is attached to the lower side wall portion, and the dash panel includes the bent portion that is bent so as to cover the upper edge portion of the lower side wall portion from the vehicle upper side and the vehicle rear side. Furthermore, the sealing material is provided in a liquid-tight state between the upper edge portion of the lower side wall portion and the bent portion of the dash panel. Consequently, in the vehicle body structure of the first aspect, liquid that has adhered to a front face of the dash panel can be prevented from passing through rearward between the front frame member and the dash panel, by the sealing material that is provided between the front frame member and the dash panel.

A vehicle body structure of a second aspect is the vehicle body structure of the first aspect, wherein the dash panel includes an up-down direction extending portion that is positioned further toward a vehicle front side than the bent portion and that extends toward the vehicle upper side from the bent portion, and a projecting portion that extends toward the vehicle front side from a connection portion between the bent portion and a lower end portion of the up-down direction extending portion.

The dash panel of the vehicle body structure of the second aspect includes the up-down direction extending portion that is positioned further toward the vehicle front side than the bent portion and that extends toward the vehicle upper side from the bent portion, and the projecting portion that extends toward the vehicle front side from the connection portion between the bent portion and the lower end portion of the up-down direction extending portion. Consequently, it becomes less likely for liquid that has adhered to the front face of the up-down direction extending portion of the dash panel to move toward a space between the front frame member and the dash panel.

As explained above, the vehicle body structure according to the present disclosure has an excellent advantageous effect in that liquid that has adhered to the front face of the resin dash panel that is supported by the die-cast front frame member can be prevented from passing through rearward between the front frame member and the dash panel.

### BRIEF DESCRIPTION OF THE DRAWINGS

Exemplary embodiments of the present disclosure will be described in detail based on the following figures, wherein:

FIG. 1 is an exploded perspective view of a front frame member and a dash panel according to an exemplary embodiment, viewed from a rear side;

FIG. 2 is a front view of the dash panel;

FIG. 3 is a perspective view illustrating a portion of the dash panel in an enlarged manner, viewed from a front side; and

FIG. 4 is a cross-sectional view taken along line 4-4 in FIG. 1.

### DETAILED DESCRIPTION

A vehicle body structure according to an exemplary embodiment will be explained below, with reference to the appended drawings. It should be noted that in each of the drawings, arrow UP, arrow FR, and arrow LH respectively indicate an upper side in a vehicle up-down direction, a front side in a vehicle front-rear direction, and a left side in a vehicle left-right direction.

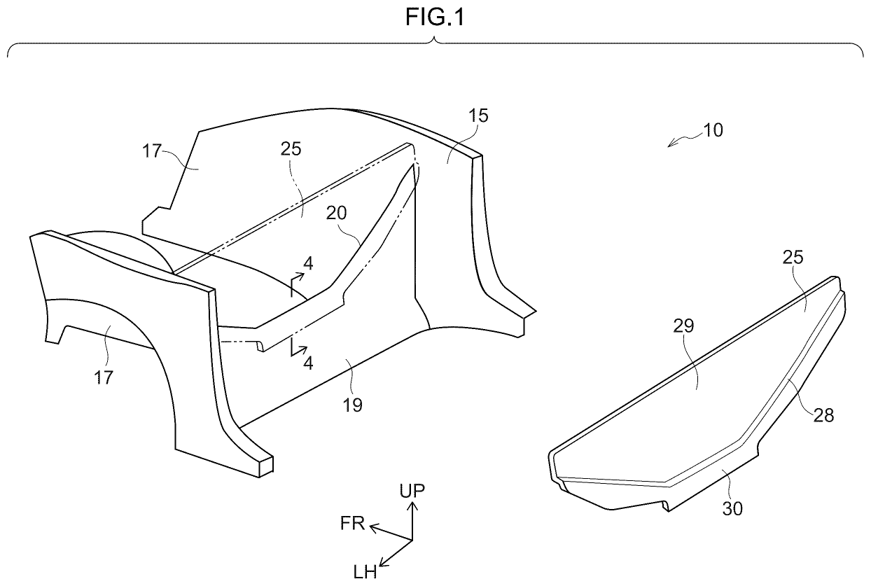

As illustrated in FIG. 1, a vehicle 10 to which the vehicle body structure of the present exemplary embodiment is applied includes a front frame member 15, which is an integral molded article made of aluminum die-cast, as a portion of a vehicle body frame member. The front frame member 15 includes a left and right pair of front wheel houses 17, and a lower side wall portion 19 that connects rear portions of the left and right front wheel houses 17 together. The lower side wall portion 19 is a plate-shaped member that is substantially orthogonal to the front-rear direction. An upper edge portion 20 of the lower side wall portion 19 is positioned further downward than upper ends of the left and right front wheel houses 17. Furthermore, in front view, the upper edge portion 20 is recessed so as to be convex downward. When the front frame member 15 is installed at the vehicle 10, an engine room is formed directly in front of the lower side wall portion 19, and a vehicle interior space (cabin) is formed directly behind the lower side wall portion 19.

A dash panel 25, which is an integral molded article made of resin, is attached to the front frame member 15. The dash panel 25 is a plate-shaped member. In front view, a lower portion shape of the dash panel 25 is a convex shape directed approximately downward.

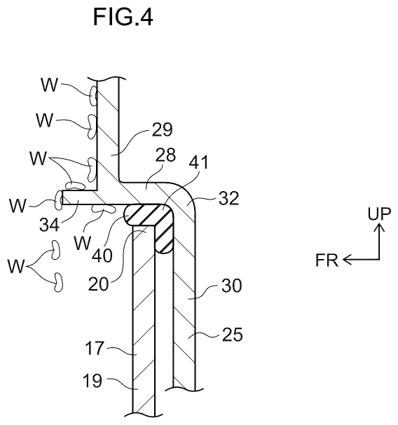

As illustrated in FIGS. 1, 2, and 4, a step portion 28 is formed at a lower portion of the dash panel 25. A front face shape of the step portion 28 is substantially the same as that of the upper edge portion 20 of the lower side wall portion 19 of the front frame member 15. A left end of the step portion 28 is positioned further toward the right side than a left end face of the dash panel 25, and a right end of the step portion 28 is positioned further toward the left side than a right end face of the dash panel 25. A portion of the dash panel 25 that is positioned above the step portion 28 is an upper planar portion (up-down direction extending portion) 29, and a portion of the dash panel 25 that is positioned below the step portion 28 is a lower planar portion 30. As illustrated in FIG. 4, a lower edge portion of the upper planar portion 29 is connected to a front edge portion of the step portion 28, and an upper edge portion of the lower planar portion 30 is connected to a rear edge portion of the step portion 28. The upper planar portion 29 and the lower planar portion 30 are substantially orthogonal to the vehicle front-rear direction. As illustrated in FIGS. 1 and 4, the lower planar portion 30 is offset rearward from the upper planar portion 29. Further, a portion including the step portion 28 and the upper edge portion of the lower planar portion 30 configures a bent portion 32. As is apparent from FIG. 4, a cross-sectional shape of the bent portion 32 is substantially L-shaped. Furthermore, a projecting portion 34 is provided projecting toward a vehicle front side from a connection portion between a front edge portion of the bent portion 32 (the front edge portion of the step portion 28) and the lower edge portion of the upper planar portion 29. A front face shape of the projecting portion 34 is substantially the same as that of the step portion 28. The projecting portion 34 is formed at the dash panel 25 over substantially an entire area of the step portion 28 in the left-right direction.

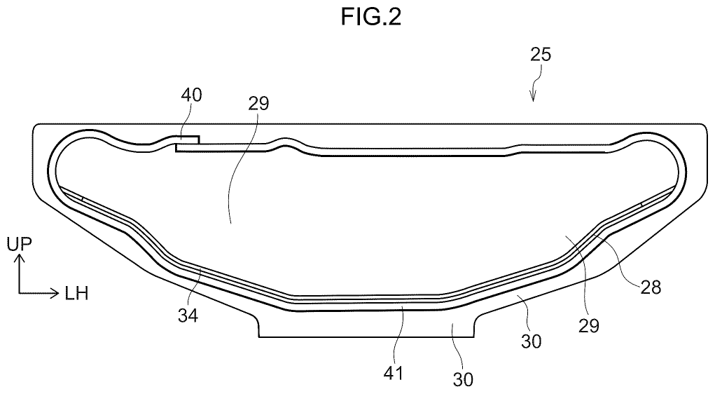

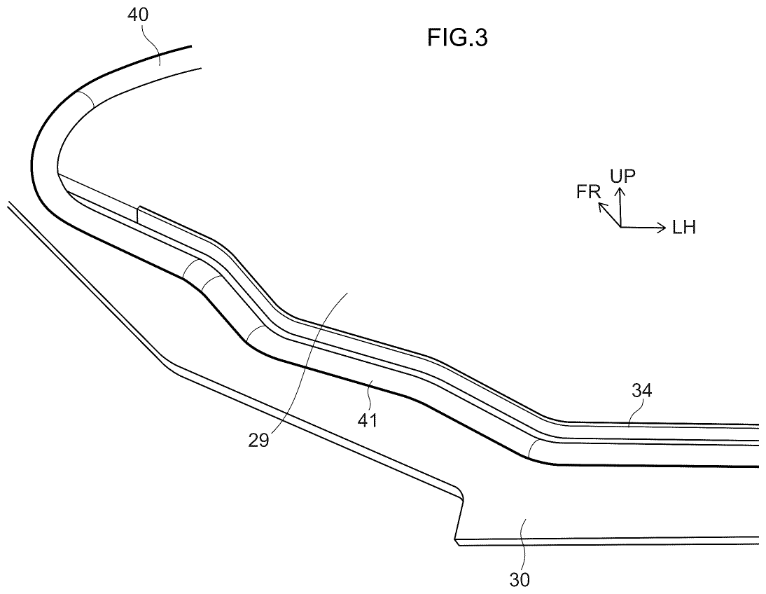

Further, as illustrated in FIGS. 2 and 3, a sealing material 40, whose front face shape is substantially annular shaped, is fixed in a liquid-tight state to a front face of the dash panel 25. The sealing material 40 is elastically deformable. In front view, the step portion 28 (the projecting portion 34) is positioned at an inner peripheral side of the sealing material 40. More specifically, in a front view, a lower portion 41 of the sealing material 40 is positioned directly below the step portion 28 (the projecting portion 34), and a minute gap in the up-down direction is formed between the step portion 28 (the projecting portion 34) and the lower portion 41. A front face shape of the lower portion 41 is substantially the same as the front face shape of the step portion 28 (the projecting portion 34).

When the dash panel 25, which is integrated with the sealing material 40, is attached to the front frame member 15, the dash panel 25 is brought close to the lower side wall portion 19 from the rear side of the front frame member 15 as illustrated in FIG. 1. Further, while a lower end portion of the dash panel 25 is in contact with an upper end portion of the lower side wall portion 19 (refer to the imaginary lines in FIG. 1), the step portion 28 (the projecting portion 34) is positioned directly above the upper edge portion 20 of the lower side wall portion 19, and the lower portion 41 of the sealing material 40 is pressed against the upper edge portion 20 (refer to FIG. 4). Consequently, the bent portion 32 covers the upper edge portion 20 of the lower side wall portion 19 from the vehicle upper side and the vehicle rear side. Furthermore, a portion of the lower portion 41 of the sealing material 40 is deformed upward by the upper edge portion 20 of the lower side wall portion 19, and the lower portion 41 contacts the upper edge portion 20 of the lower side wall portion 19 in a liquid-tight state. It should be noted that, although a relatively large gap is formed between a rear face of the lower side wall portion 19 and a front face of the lower planar portion 30 in FIG. 4 for convenience of explanation, in actuality, the gap between the rear face of the lower side wall portion 19 and the front face of the lower planar portion 30 is minute.

Further, plural portions of the lower end portion of the dash panel 25 and the upper end portion of the lower side wall portion 19 that overlap with each other in the front-rear direction are fixed to each other. Consequently, the front frame member 15 and the dash panel 25 are integrated with each other.

### Operation and Effects

Next operation and effects of the present exemplary embodiment will be explained.

As illustrated in FIG. 4, a case in which a liquid W, such as rain or the like, has adhered to the front face of the upper planar portion 29 of the dash panel 25 is assumed. This liquid W flows downward along the front face of the upper planar portion 29. The liquid W sometimes flows toward the front along an upper face of the projecting portion 34. In such a case, there is a high probability that the liquid W will fall downward from a front end face of the projecting portion 34. In other words, a risk that the liquid W will flow from the front end face of the projecting portion 34 to the lower face of the projecting portion 34 is small.

Next, a case in which the liquid W has flowed from the front end face of the projecting portion 34 to the lower face of the projecting portion 34 is assumed. As described above, the bent portion 32 covers the upper edge portion 20 of the lower side wall portion 19 from the vehicle upper side and the vehicle rear side. Further, the sealing material 40 is provided in a liquid-tight state between the upper edge portion 20 of the lower side wall portion 19 and the bent portion 32. For this reason, even if the liquid W that has adhered to the lower face of the projecting portion 34 flows rearward along the projecting portion 34, the sealing material 40 prevents the liquid W from passing through rearward between the upper edge portion 20 of the lower side wall portion 19 of the front frame member 15 and the bent portion 32 of the dash panel 25. Consequently, there is almost no risk that the liquid W will move toward the minute gap between the rear face of the lower side wall portion 19 and the front face of the lower planar portion 30.

Although the vehicle body structure of a vehicle according to the exemplary embodiment has been explained above, design modifications thereto can be appropriately carried out within a range that does not depart from the spirit of the present disclosure.

For example, a front edge portion of the projecting portion 34 that is provided at the dash panel 25 may be positioned further upward than a rear edge portion of the projecting portion 34.

The projecting portion 34 may also be omitted from the dash panel 25.

What is claimed is:

1. A vehicle body structure comprising:
a die-cast front frame member including left and right front wheel houses, and a lower side wall portion that connects the left and right front wheel houses and that extends in a vehicle up-down direction; and
a resin dash panel that is attached to the lower side wall portion,
wherein:
the dash panel includes a bent portion that is bent so as to cover an upper edge portion of the lower side wall portion from a vehicle upper side and a vehicle rear side, and
a sealing material is provided in a liquid-tight state between the upper edge portion and the bent portion.

2. The vehicle body structure according to claim 1, wherein the dash panel includes:
an up-down direction extending portion that is positioned further toward a vehicle front side than the bent portion and that extends toward the vehicle upper side from the bent portion, and
a projecting portion that extends toward the vehicle front side from a connection portion between the bent portion and a lower end portion of the up-down direction extending portion.
